(19) United States
(12) Patent Application Publication
(10) Pub. No.: US 2026/0246596 A1
(43) Pub. Date: Aug. 20, 2026

(54) VARIABLE BIT ALLOCATIONS FOR LATENT MESSAGE SEGMENTS

(71) Applicant: QUALCOMM INCORPORATED, San Diego, CA (US)

(72) Inventors: Chenxi HAO, Beijing (CN); Abdelrahman Mohamed Ahmed Mohamed IBRAHIM, San Diego, CA (US); Jay Kumar SUNDARARAJAN, San Diego, CA (US); Pavan Kumar VITTHALADEVUNI, San Diego, CA (US); Taesang YOO, San Diego, CA (US)

(21) Appl. No.: 19/159,886

(22) PCT Filed: May 3, 2023
(86) PCT No.: PCT/CN2023/091942

§ 371 Date: Aug. 26, 2025

(51) Int. Cl. H04L 5/00; H04W 72/21

(52) U.S. Cl. CPC H04L 5/0094; H04W 72/21

(57) ABSTRACT

Various aspects of the present disclosure generally relate to wireless communication. In some aspects, a user equipment (UE) may select variable bit allocations that indicate quantization sizes for respective segments of a latent message, the latent message representing channel state information. The UE may quantize the respective segments to form the latent message based at least in part on the quantization sizes for the respective segments. The UE may transmit the variable bit allocations with the latent message. Numerous other aspects are described.

### FIELD OF THE DISCLOSURE

Aspects of the present disclosure generally relate to wireless communication and to techniques and apparatuses for transmitting variable bit allocations for segments of a latent message.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include selecting variable bit allocations that indicate quantization sizes for respective segments of a latent message, the latent message representing channel state information (CSI). The method may include quantizing the respective segments to form the latent message based at least in part on the quantization sizes for the respective segments. The method may include transmitting the variable bit allocations with the latent message.

Some aspects described herein relate to a method of wireless communication performed by a network entity. The method may include receiving variable bit allocations with a latent message that represents CSI, the variable bit allocations indicating quantization sizes for quantized segments of the latent message. The method may include decoding the quantized segments based at least in part on the quantization sizes indicated by the variable bit allocations.

Some aspects described herein relate to a method of wireless communication performed by a UE. The method may include generating a first part of a latent message for a first set of ports or subbands and a second part of the latent message for a second set of ports or subbands, the latent message being associated with CSI. The method may include transmitting the latent message.

Some aspects described herein relate to a UE for wireless communication. The UE may include one or more memories and one or more processors coupled to the one or more memories. The one or more processors may be configured to select variable bit allocations that indicate quantization sizes for respective segments of a latent message, the latent message representing CSI. The one or more processors may be configured to quantize the respective segments to form the latent message based at least in part on the quantization sizes for the respective segments. The one or more processors may be configured to transmit the variable bit allocations with the latent message.

Some aspects described herein relate to a network entity for wireless communication. The network entity may include one or more memories and one or more processors coupled to the one or more memories. The one or more processors may be configured to receive variable bit allocations with a latent message that represents CSI, the variable bit allocations indicating quantization sizes for quantized segments of the latent message. The one or more processors may be configured to decode the quantized segments based at least in part on the quantization sizes indicated by the variable bit allocations.

Some aspects described herein relate to a UE for wireless communication. The UE may include one or more memories and one or more processors coupled to the one or more memories. The one or more processors may be configured to generate a first part of a latent message for a first set of ports or subbands and a second part of the latent message for a second set of ports or subbands, the latent message being associated with CSI. The one or more processors may be configured to transmit the latent message.

Some aspects described herein relate to a non-transitory computer-readable medium that stores a set of instructions for wireless communication by a UE. The set of instructions, when executed by one or more processors of the UE, may cause the UE to select variable bit allocations that indicate quantization sizes for respective segments of a latent message, the latent message representing CSI. The set of instructions, when executed by one or more processors of the UE, may cause the UE to quantize the respective segments to form the latent message based at least in part on the quantization sizes for the respective segments. The set of instructions, when executed by one or more processors of the UE, may cause the UE to transmit the variable bit allocations with the latent message.

Some aspects described herein relate to a non-transitory computer-readable medium that stores a set of instructions for wireless communication by a network entity. The set of instructions, when executed by one or more processors of the network entity, may cause the network entity to receive variable bit allocations with a latent message that represents CSI, the variable bit allocations indicating quantization sizes for quantized segments of the latent message. The set of instructions, when executed by one or more processors of the network entity, may cause the network entity to decode the quantized segments based at least in part on the quantization sizes indicated by the variable bit allocations.

Some aspects described herein relate to a non-transitory computer-readable medium that stores a set of instructions for wireless communication by a UE. The set of instructions, when executed by one or more processors of the UE, may cause the UE to generate a first part of a latent message for a first set of ports or subbands and a second part of the latent message for a second set of ports or subbands, the latent message being associated with CSI. The set of instructions, when executed by one or more processors of the UE, may cause the UE to transmit the latent message.

Some aspects described herein relate to an apparatus for wireless communication. The apparatus may include means for selecting variable bit allocations that indicate quantization sizes for respective segments of a latent message, the latent message representing CSI. The apparatus may include means for quantizing the respective segments to form the latent message based at least in part on the quantization sizes for the respective segments. The apparatus may include means for transmitting the variable bit allocations with the latent message.

Some aspects described herein relate to an apparatus for wireless communication. The apparatus may include means for receiving variable bit allocations with a latent message that represents CSI, the variable bit allocations indicating quantization sizes for quantized segments of the latent message. The apparatus may include means for decoding the quantized segments based at least in part on the quantization sizes indicated by the variable bit allocations.

Some aspects described herein relate to an apparatus for wireless communication. The apparatus may include means for generating a first part of a latent message for a first set of ports or subbands and a second part of the latent message for a second set of ports or subbands, the latent message being associated with CSI. The apparatus may include means for transmitting the latent message.

Aspects generally include a method, apparatus, system, computer program product, non-transitory computer-readable medium, UE, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of beam management procedures, in accordance with the present disclosure.

FIG. 5 is a diagram illustrating an example associated with transmitting variable bit allocations for segments of a latent message for channel state information (CSI) feedback, in accordance with the present disclosure.

FIG. 6 is a diagram illustrating an example of selecting variable bit allocations, in accordance with the present disclosure.

FIG. 7 is a diagram illustrating an example of ordering variable bit allocations and quantized segments, in accordance with the present disclosure.

FIG. 8 is a diagram illustrating an example of partitioning and subsampling, in accordance with the present disclosure.

FIG. 9 is a diagram illustrating an example of ordering latent message sets, in accordance with the present disclosure.

FIG. 10 is a diagram illustrating an example process performed, for example, by a UE, in accordance with the present disclosure.

FIG. 11 is a diagram illustrating an example process performed, for example, by a network entity, in accordance with the present disclosure.

FIG. 12 is a diagram illustrating an example process performed, for example, by a UE, in accordance with the present disclosure.

FIG. 13 is a diagram of an example apparatus for wireless communication, in accordance with the present disclosure.

FIG. 14 is a diagram of an example apparatus for wireless communication, in accordance with the present disclosure.

### DETAILED DESCRIPTION

A user equipment (UE) may measure reference signals and report channel state information (CSI) feedback that provides information for the channel. In some aspects, artificial intelligence (AI) or machine learning (ML)-based CSI feedback may replace a codebook by a CSI encoder and decoder. Encoder output may be a latent message that includes CSI feedback. An AI/ML-based decoder may receive the latent message. The latent message may be unstructured or structured.

According to various aspects described herein, a UE may transmit a latent message (representing CSI feedback) with quantized segments that vary in size. The quantization sizes may be indicated by variable bit allocations. A variable bit allocation may indicate a quantity of bits in length of a quantized segment of the latent message. The UE may transmit the variable bit allocations with the latent message, such as in uplink control information (UCI). By using variable quantization sizes and transmitting the variable bit allocations with the latent message, the UE may have flexibility to customize the latent message to better represent CSI feedback. The UE may conserve signaling resources and improve CSI accuracy for improved communications. The network entity may use the quantization sizes indicated by the variable bit allocations to decode the segments of the latent message.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

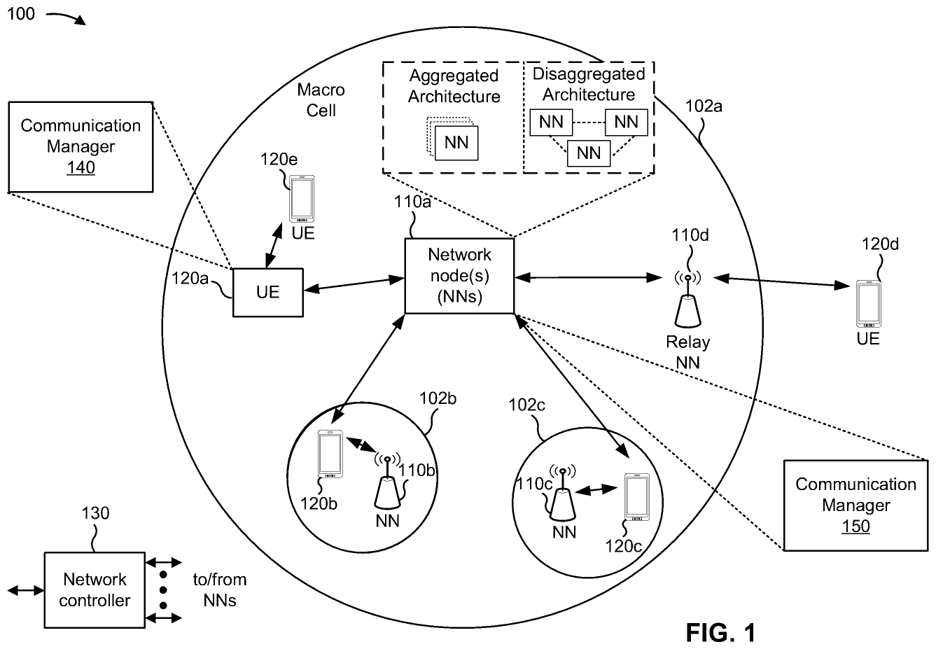

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., a UE 120) may include a communication manager 140. As described in more detail elsewhere herein, the communication manager 140 may select variable bit allocations that indicate quantization sizes for respective segments of a latent message, the latent message representing CSI. The communication manager 140 may quantize the respective segments to form the latent message based at least in part on the quantization sizes for the respective segments. The communication manager 140 may transmit the variable bit allocations with the latent message.

In some aspects, the communication manager 140 may generate a first part of a latent message for a first set of ports or subbands and a second part of the latent message for a second set of ports or subbands, the latent message being associated with CSI. The communication manager 140 may transmit the latent message. Additionally, or alternatively, the communication manager 140 may perform one or more other operations described herein.

In some aspects, a network entity (e.g., a network node 110) may include a communication manager 150. As described in more detail elsewhere herein, the communication manager 150 may receive variable bit allocations with a latent message that represents CSI, the variable bit allocations indicating quantization sizes for quantized segments of the latent message. The communication manager 150 may decode the quantized segments based at least in part on the quantization sizes indicated by the variable bit allocations. Additionally, or alternatively, the communication manager 150 may perform one or more other operations described herein.

As indicated above, FIG. 1 is provided as an example. Other examples may differ from what is described with regard to FIG. 1.

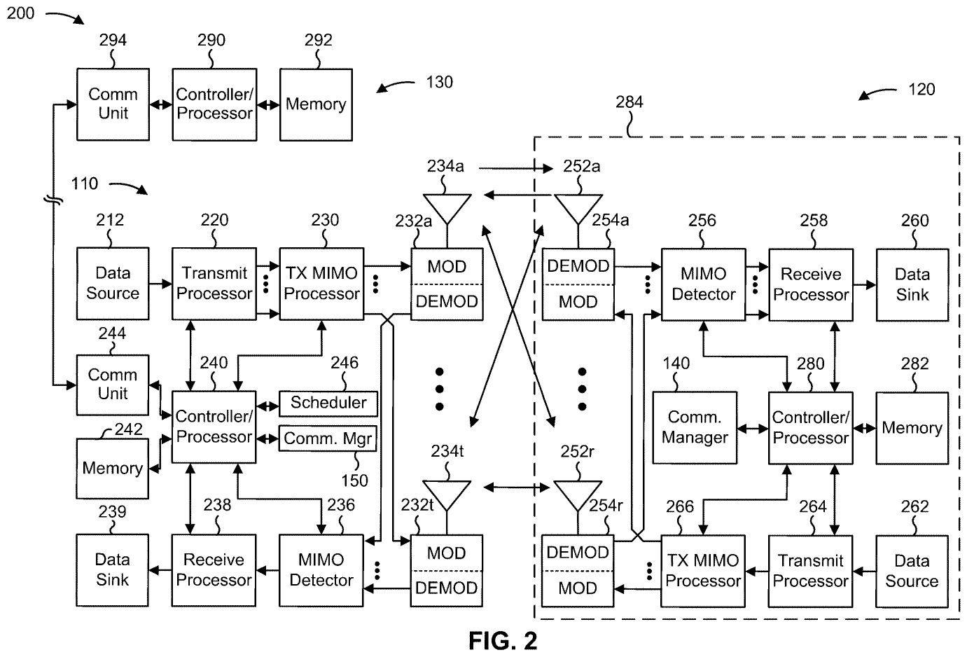

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

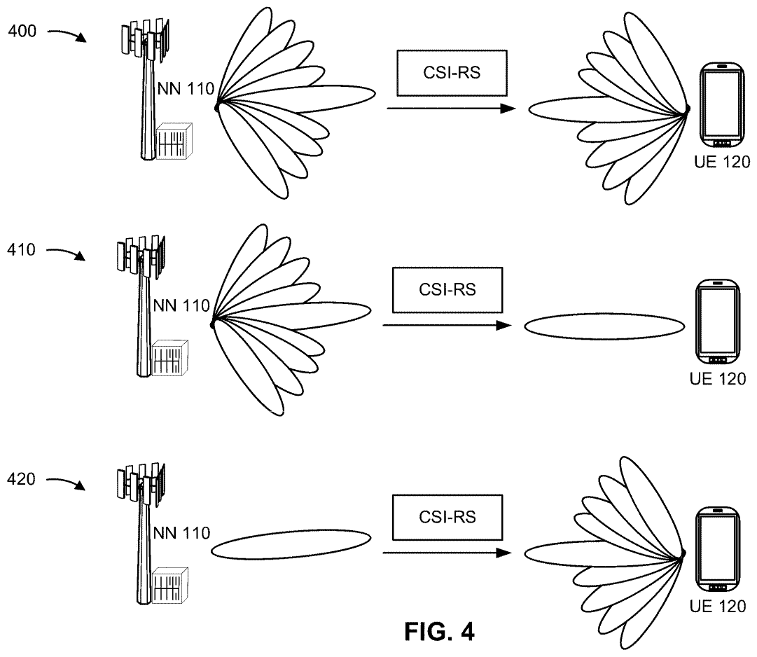

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-14).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-14).

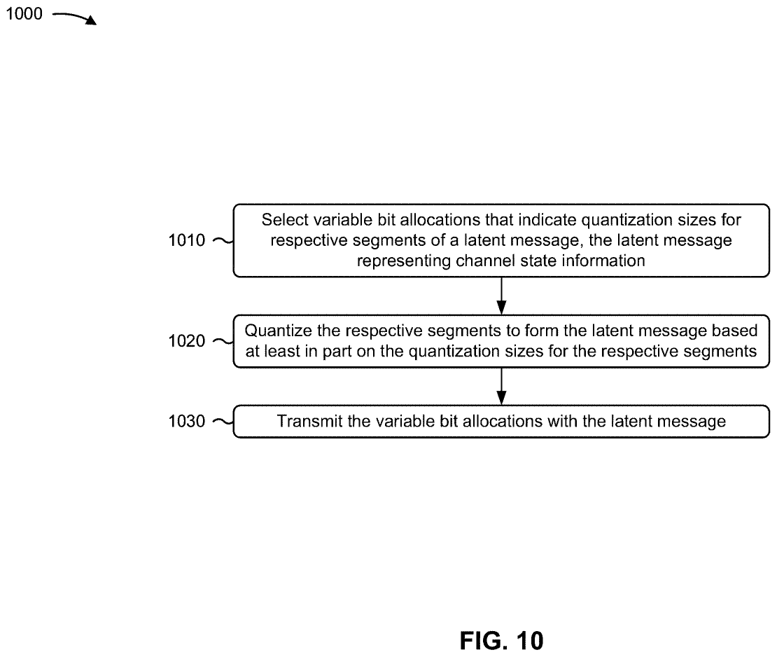

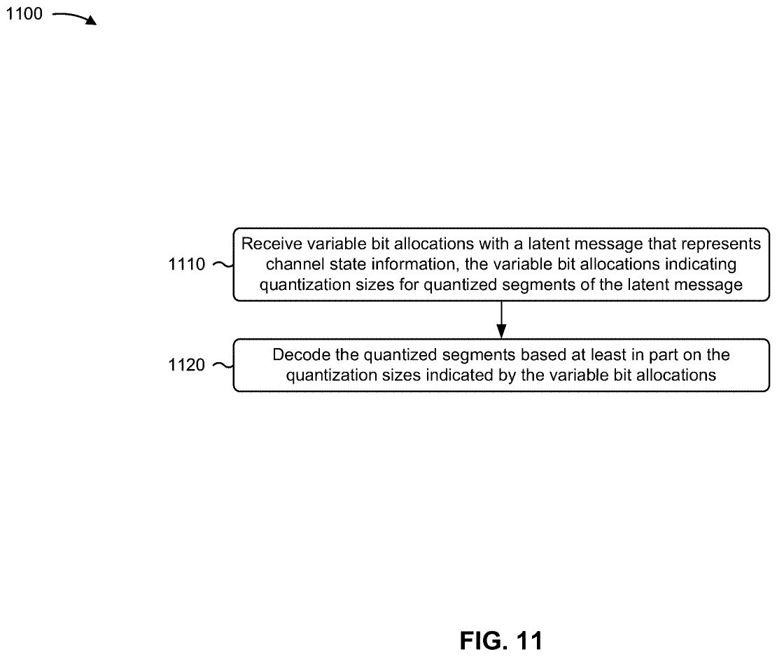

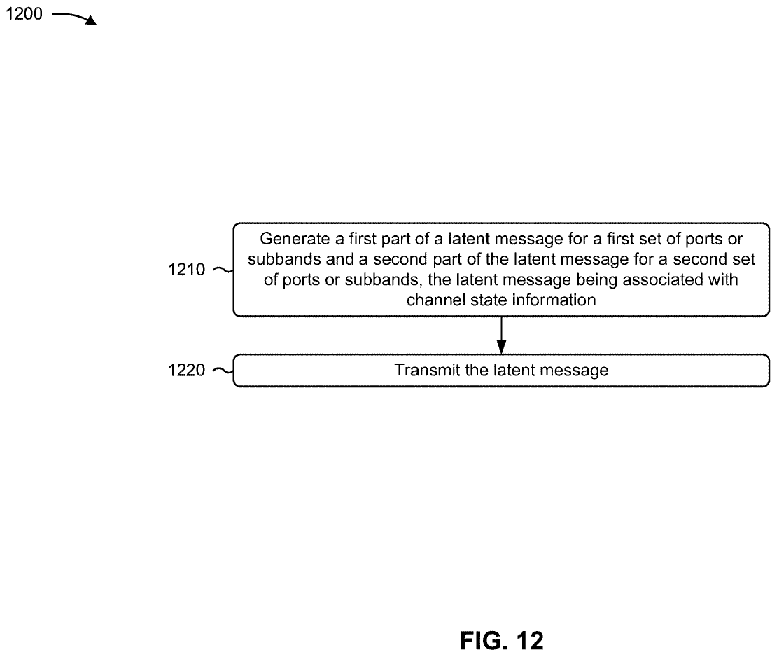

A controller/processor of a network entity (e.g., controller/processor 240 of the network node 110), the controller/processor 280 of the UE 120, and/or any other component(s) of FIG. 2 may perform one or more techniques associated with transmitting variable bit allocations for segments of a latent message for CSI feedback, as described in more detail elsewhere herein. For example, the controller/processor 240 of the network node 110, the controller/processor 280 of the UE 120, and/or any other component(s) of FIG. 2 may perform or direct operations of, for example, process 1000 of FIG. 10, process 1100 of FIG. 11, process 1200 of FIG. 12, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1000 of FIG. 10, process 1100 of FIG. 11, process 1200 of FIG. 12, and/or other processes as described herein. In some examples, executing instructions may include running the instructions, converting the instructions, compiling the instructions, and/or interpreting the instructions, among other examples.

In some aspects, a UE (e.g., a UE 120) includes means for selecting variable bit allocations that indicate quantization sizes for respective segments of a latent message, the latent message representing CSI; means for quantizing the respective segments to form the latent message based at least in part on the quantization sizes for the respective segments; and/or means for transmitting the variable bit allocations with the latent message.

In some aspects, the UE includes means for generating a first part of a latent message for a first set of ports or subbands and a second part of the latent message for a second set of ports or subbands, the latent message being associated with CSI; and/or means for transmitting the latent message. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., a network node 110) includes means for receiving variable bit allocations with a latent message that represents CSI, the variable bit allocations indicating quantization sizes for quantized segments of the latent message; and/or means for decoding the quantized segments based at least in part on the quantization sizes indicated by the variable bit allocations. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

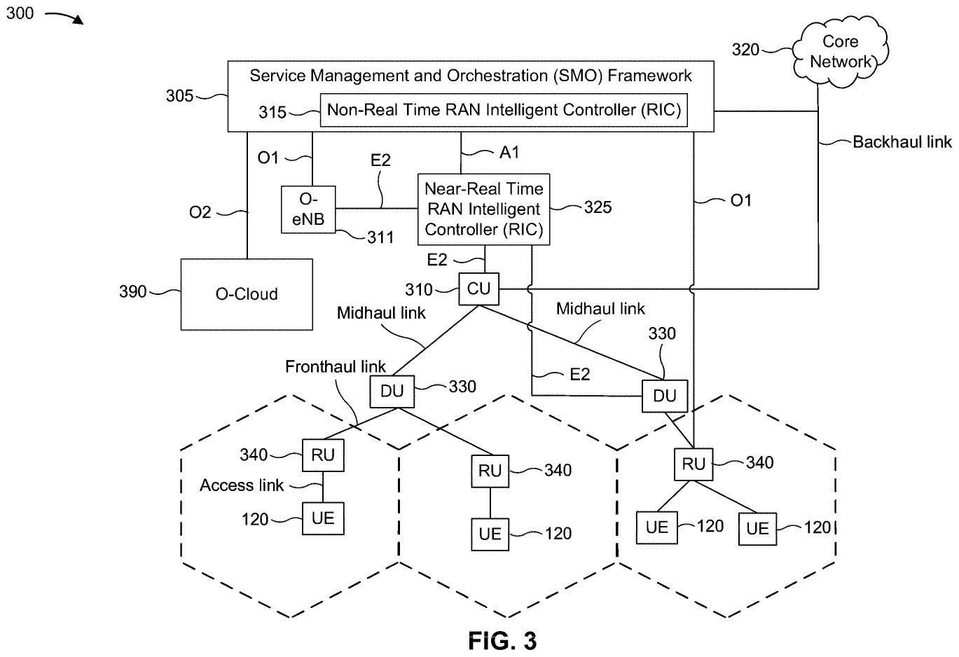

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating examples 400, 410, and 420 of beam management procedures, in accordance with the present disclosure. As shown in FIG. 4, examples 400, 410, and 420 include a UE 120 in communication with a network entity (e.g., network node 110) in a wireless network (e.g., wireless network 100). However, the devices shown in FIG. 4 are provided as examples, and the wireless network may support communication and beam management between other devices (e.g., between a UE 120 and a network node 110 or TRP, between a mobile termination node and a control node, between an IAB child node and an IAB parent node, and/or between a scheduled node and a scheduling node). In some aspects, the UE 120 and the network node 110 may be in a connected state (e.g., a radio resource control (RRC) connected state).

As shown in FIG. 4, example 400 may include a network node (NN) 110 and a UE 120 communicating to perform beam management using CSI reference signals (CSI-RSs). Example 400 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 4 and example 400, CSI-RSs may be configured to be transmitted from the network node 110 to the UE 120. The CSI-RSs may be configured to be periodic (e.g., using RRC signaling), semi-persistent (e.g., using MAC control element (MAC CE) signaling), and/or aperiodic (e.g., using downlink control information (DCI)).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the base station may use a transmit beam to transmit (e.g., with repetitions) each CSI-RS at multiple times within the same reference signal (RS) resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 400 has been described in connection with CSI-RSs, the first beam management process may also use synchronization signal blocks (SSBs) for beam management in a similar manner as described above.

As shown in FIG. 4, example 410 may include a network node 110 and a UE 120 communicating to perform beam management using CSI-RSs. Example 410 depicts a second beam management procedure (e.g., P2 CSI-RS beam management). The second beam management procedure may be referred to as a beam refinement procedure, a base station beam refinement procedure, a TRP beam refinement procedure, and/or a transmit beam refinement procedure. As shown in FIG. 4 and example 410, CSI-RSs may be configured to be transmitted from the network node 110 to the UE 120. The CSI-RSs may be configured to be aperiodic (e.g., using DCI), or A-CSI. The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RSs (e.g., measured by the UE 120 using the single receive beam) reported by the UE 120.

As shown in FIG. 4, example 420 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the network node 110 to the UE 120. The CSI-RSs may be configured to be aperiodic (e.g., using DCI). The third beam management process may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the base station may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams).

Coherent joint transmission (CJT) involves multiple transmitters that each transmit a message with a phase that is constructively combined at a receiver. CJT may include beamforming with antennas that are not colocated and that correspond to different TRPs. CJT may improve the signal power and spatial diversity of communications in an NR network.

The UE 120 may measure CSI-RSs and transmit a CSI report that indicates CSI, such as a precoding matrix indicator (PMI). A PMI is a matrix that represents how data is transmitted on antenna ports. The CSI report may include a codebook, which is a set of precoders or one or more PMIs. A Type-I codebook may include predefined matrices. A Type-II codebook may include a more detailed CSI report for multi-user MIMO and may include a group of beams. CSI acquisition may be enhanced for CJT for multiple TRPs (e.g., up to 4 TRPs). An enhanced Type-II codebook (eType-II codebook) may be eType-II codebook structure can be generalized as

$$W = {W}_{1} \times {\tilde{W}}_{2} \times {W}_{f}^{H} ,$$

where the precoder for a certain layer on N₃ subbands is written as

$$W = {W}_{1} \times {\tilde{W}}_{2} \times {W}_{f}^{H} = ( \begin{matrix}{\sum }_{i = 0}^{L - 1} {\sum }_{m = 0}^{M - 1} {v}_{{m}_{1}^{( i )} , {m}_{2}^{( i )}} {c}_{i , m} \cdot {f}_{{m}_{3}^{( m )}}^{H} \\ {\sum }_{i = 0}^{L - 1} {\sum }_{m = 0}^{M - 1} {v}_{{m}_{1}^{( i )} {m}_{2}^{( i )}} {c}_{i + L , m} \cdot {f}_{{m}_{3}^{( m )}}^{H}\end{matrix} ) ,$$

where c_{i,m,l} is the combination coefficient for the i-th spatial basis (beam), m-th frequency basis, and \tilde{W}₂ is the 2L×M matrix containing all coefficients, such as

$${v}_{{m}_{1}^{( i )} , {m}_{2}^{( i )}}$$

is a Nₜ×1 spatial domain (SD) basis, W₁ is an Nₜ×2L matrix containing all SD bases, and

$${f}_{{m}_{3}^{( m )}}^{H}$$

is 1×N₃ FD basis;

$${W}_{f}^{H}$$

is a M×N₃ matrix containing all FD bases. L may be a spatial domain basis, such as a beam configuration or TRPs. M may be a frequency domain basis. The eType-II extension to CJT may apply separately on TRPs then combine with co-phasing:

$$W = [ \begin{matrix}W ( 1 ) \\ φ ( 2 ) \cdot W ( 2 )\end{matrix} ] ,$$

where W(1) and W(2) are the associated eType-II precoders for TRP1 and TRP2, and φ(2) is the scaler (or vector for different subbands) for co-phasing. The eType-II precoders may apply jointly across TRPs, where

$$W = [ \begin{matrix}W ( 1 ) \\ W ( 2 )\end{matrix} ] ,$$

and the difference vs. 1 is that W(1) and W(2) are jointly calculated.

For eType-II CSI, parameters may include an SD basis number configuration represented as #SD: L={2,4,6}. A frequency domain basis number may be represented as #FD:

$${M}_{1} = {M}_{2} = ⌈ {p}_{1} \times \frac{{N}_{3}}{R} ⌉ and {M}_{3} = {M}_{4} = ⌈ {p}_{3} \times \frac{{N}_{3}}{R} ⌉ .$$

Coefficients may include amplitude scaling factors (p) and beta offset factors (β). A non-zero coefficient (NZC) may be represented as #NZC: K₀=┌β×2LM₁┐. A network entity may use an RRC message to configure a (1 out of 8) combination of (L, p₁, p₃, β).

In some aspects, artificial intelligence (AI) or machine learning (ML)-based CSI feedback may replace the codebook by a CSI encoder and decoder. An AI/ML-based encoder may be analogous to a PMI searching algorithm. Encoder input may include a downlink channel matrix H, downlink precoders V, or an interference covariance matrix Rₙₙ. Encoder output may be a latent message that includes CSI feedback. An AI/ML-based decoder may receive the latent message. The decoder may be analogous to the PMI codebook that is used to translate CSI reporting bits into a PMI codeword. Decoder output may include the downlink channel matrix H, a transmit covariance matrix, downlink precoders V, an interference covariance matrix, a raw channel, or a whitened channel (e.g., whitened by a demodulation filter).

The latent message may be unstructured or structured. An unstructured latent message may be a series of bits with a payload that is explicitly configured or derived based on the quantity of ports, the quantity of subbands, and/or the rank. A structured latent message may be structured by dz, Q, and cw_len, where dz is a dimension of the latent message, Q is a quantity of bits per quantization dimension, and cw_len is a codeword length of a segment. Multiple allowed combinations of {dz, Q, cw_len} may be specified. In an example, the total dimension dz of the latent message may be 64, or {z₁, z₂, z₃, z₄, z₅, . . . , z₆₄}, and cw_len=4 may be the length for the vector quantization (i.e., the VQ is applied to vector of size cw_len*1). The latent message may be quantized by Q bits. However, under these current schemes signaling resources may be wasted or CSI accuracy may be reduced.

As indicated above, FIG. 4 is provided as an example of beam management procedures. Other examples of beam management procedures may differ from what is described with respect to FIG. 4. For example, the UE 120 and the network node 110 may perform the third beam management procedure before performing the second beam management procedure, and/or the UE 120 and the network node 110 may perform a similar beam management procedure to select a UE transmit beam.

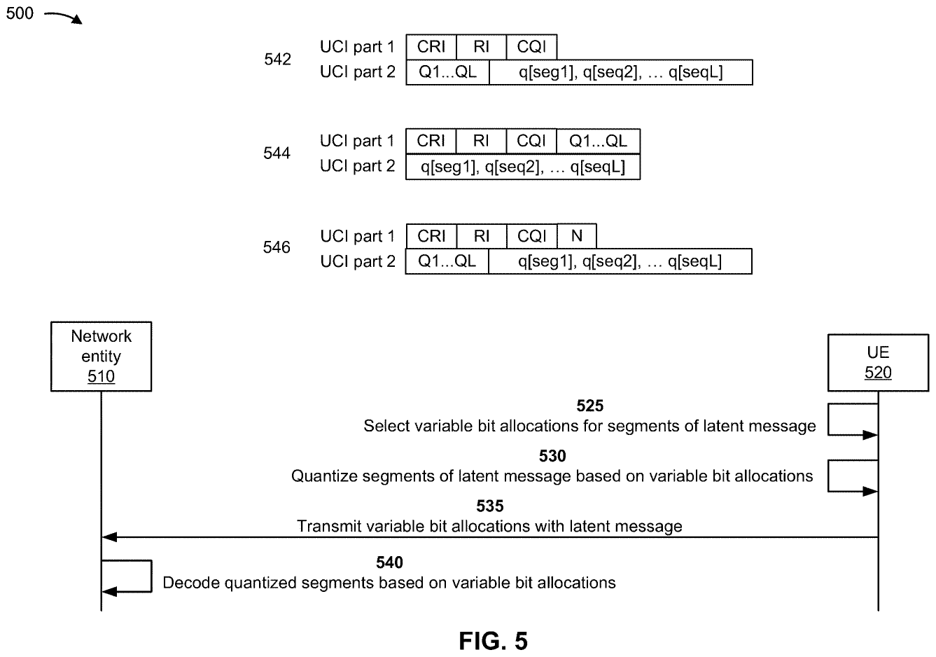

FIG. 5 is a diagram illustrating an example 500 associated with transmitting variable bit allocations for segments of a latent message for CSI feedback, in accordance with the present disclosure. As shown in FIG. 5, a network entity 510 (e.g., network node 110) and a UE 520 (e.g., UE 120) may communicate with one another via a wireless network (e.g., wireless network 100).

According to various aspects described herein, the UE 520 may transmit a latent message of CSI feedback with quantized segments that vary in size. The quantization sizes may be indicated by variable bit allocations. A variable bit allocation may indicate a quantity of bits in length of a quantized segment of the latent message. Variable bit allocations of {Q1, Q2, . . . , QL} bits may be used for quantized segments {q[seg1], q[seg2], . . . , q[segL]}, respectively, for L segments of the latent message, and q indicates that the segment is quantized. For example, Q1 may indicate 4 bits, which means that the first segment seg1 of CSI in the latent message is quantized to 4 bits. Q2 may indicate 5 bits, which means that the second segment seg2 of CSI in the latent message may be quantized to 5 bits. Q3 may indicate 3 bits, which means that the third segment seg3 of CSI in the latent message may be quantized to 3 bits, and so forth. The variable bit allocations may be provided with the latent message. By using variable quantization sizes and transmitting the variable bit allocations with the latent message, the UE 520 may have flexibility to customize the latent message to better represent CSI feedback. The UE 520 may conserve signaling resources and improve CSI accuracy for improved communications. The network entity 510 may use the quantization sizes indicated by the variable bit allocations to decode the segments of the latent message.

Example 500 shows use of variable sized segments of a latent message for CSI feedback. As shown by reference number 525, the UE 520 may select variable bit allocations for segments of a latent message, the latent message representing CSI feedback. The UE 520 may select the quantization sizes for the segments based at least in part on the characteristics of the CSI feedback and/or a configuration for CSI feedback. As shown by reference number 530, the UE 520 may quantize the segments of the latent message based at least in part on the variable bit allocations. As shown by reference number 535, the UE 520 may transmit the variable bit allocations with the latent message. As shown by reference number 540, the network entity 510 may decode the quantized segments based at least in part on the variable bit allocations. The network entity 510 may know the size of each segment and how many bits are used for the quantization of a segment.

In some aspects, the network entity 510 may configure the total payload

$${\sum }_{l = 1}^{L} {Q}_{L} = N ,$$

where N is the total size of the latent message. As shown by reference number 542, the UE 520 may indicate the variable bit allocations {Q1, Q2, . . . , QL} in UCI part 2, followed by the quantization of each segment (q[seg1], q[seg2], . . . q[segL]).

In some aspects, the UE 520 may configure the total payload

$${\sum }_{l = 1}^{L} {Q}_{L} = N .$$

As shown by reference number 544, the UE 520 may indicate the variable bit allocations {Q1, Q2, . . . , QL} in UCI part 1 and use the variable bit allocations to determine the payload for UCI part 2. The UE 520 may include the quantization of each segment in UCI part 2. Alternatively, in some aspects, as shown by reference number 546, the UE 520 may indicate N in UCI part 1, which is used to determine the payload for UCI part 2. The UE 520 may indicate the variable bit allocations {Q1, Q2, . . . , QL} in UCI part 2, followed by the quantization of each segment.

In some aspects, for the options shown in reference numbers 542, 544, and 546, the UE 520 may select the possible values for the variable bit allocations {Q1, Q2, . . . , QL} from predefined set of multiple variable bit allocations. For example, there may be two candidate values for each of the variable bit allocations {Q1, . . . , QL}, such as 2 bits or 4 bits.

As indicated above, FIG. 5 is provided as an example. Other examples may differ from what is described with regard to FIG. 5.

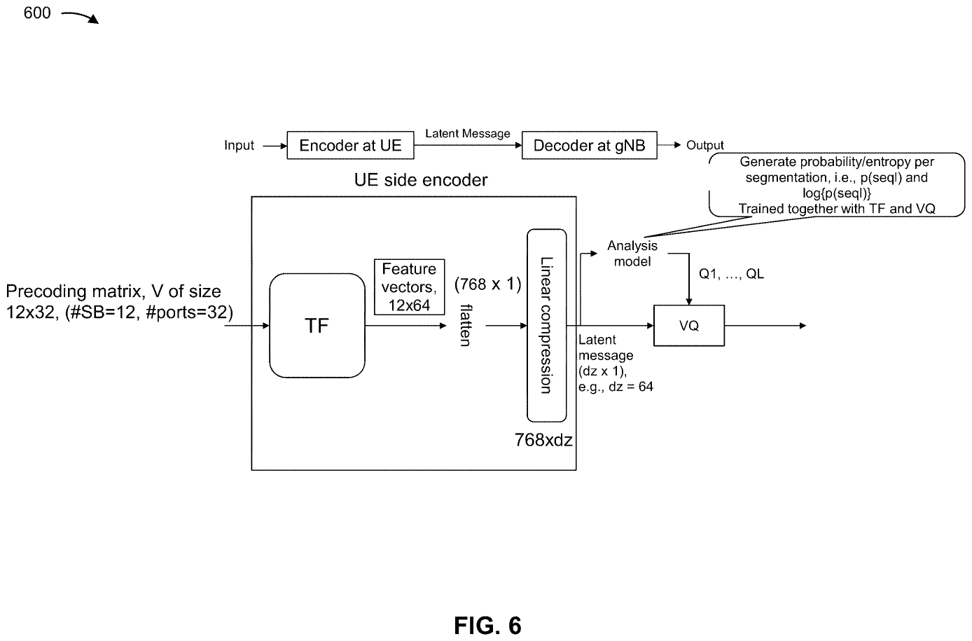

FIG. 6 is a diagram illustrating an example 600 of selecting variable bit allocations, in accordance with the present disclosure.

In some aspects, the UE 520 may select variable bit allocations using trained analysis models. For example, the UE 520 may encode a precoding matrix V to obtain the latent message with a dimension (dz) of the latent message. The encoding may include a transformer (TF) transforming the precoding matrix to feature vectors with dimensions 12×64 that is flattened. After linear compression, the latent message has a dimension of 64. The UE 520 may use a trained analysis model to select variable bit allocations for segments of the latent message to obtain VQ (quantized segments). In some aspects, the UE 520 may generate a probability or entropy per segment (e.g., p(seql) and log{p(seql)}. The analysis model may train the entropies together with the TF and the VQ. The UE 520 may use the probability or entropy per segment to select variable allocations for each segment of the latent message.

In some aspects, the UE 520 may use one analysis model to output the probability or entropy for all segments. The UE 520 may use multiple analysis models for the purpose of different configurations, including two-sided CSI feedback enc-dec models designed for different scenarios or rank/layer specific models.

As indicated above, FIG. 6 is provided as an example. Other examples may differ from what is described with respect to FIG. 6.

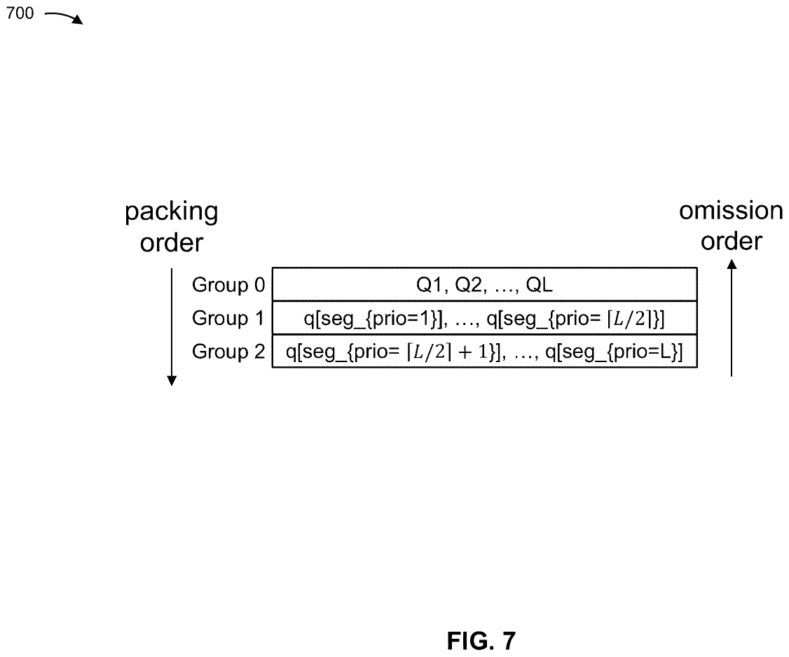

FIG. 7 is a diagram illustrating an example 700 of ordering variable bit allocations and quantized segments, in accordance with the present disclosure.

In some aspects, segments of the latent message may be ordered based at least in part on respective priorities of the segments. For example, the segments may be prioritized by bit allocation (e.g., larger bit allocation sizes have higher priority), by segment index, and then by layer index. In another example, the segments may be prioritized by bit allocation (e.g., bit allocation size), by layer index, and then by segment index. A first segment (seg1) may have a higher priority than a second segment (seg2) if Q1>Q2. If Q1=Q2, seg1 may have a higher priority than seg2. The UE 520 may use a priority function, such as prio(l, i)=(Qₘₐₓ−Qₗ)×L×i+l×i+i, where Qₘₐₓ is the maximum quantization bits among all the segments or the maximum possible quantization bits, l is the segment index, and i is the layer index. In another example, the latent message may represent information of all layers, such that a certain segment l may represent information of all layers. In this case, the priority function may be written as prio(l)=(Qₘₐₓ−Q1)×L+1. A smaller value of prio(l, i) may have a higher priority. The UE 520 may map quantized segments into UCI fields based at least in part on priority values of the segments. A lower value of prio(l, i) or prio(l) (higher priority order) may be mapped first, followed by a higher value of prio(l, i) or prio(l) (lower priority order).

In some aspects, variable bit allocations may be grouped in to bit allocation groups, and segments may be grouped into segment groups. Example 700 shows a packing order of such groups. Group 0 may include an indication of variable bit allocations Q1, . . . , QL. Group 1 may be a first half of the segments, i.e., 1 . . . ┌L/2┐. Group 2 may be a second half of the segments, i.e., ┌L/2┐+1, . . . L. FIG. 7 illustrates an example where rank 1 is reported or where latent message includes information of all layers so that there are total L segments. In some other examples, the latent message may include layer information sequentially, so that there are totally RI×L segments and Group 1 includes segments 1 . . . ┌L*RI/2┐, Group 2 includes remaining segments ┌L*RI/2┐+1, . . . L×RI. The UE 520 may map Group 0, followed by Group 1 and Group 2 in UCI part 2 (Group 1 has a higher priority than Group 2). In some aspects, the UE 520 may omit groups from the packing. For example, lower priority groups may be omitted before higher priority groups. In example 700, Group 2 may be omitted before Group 1 is omitted. Group 1 may be omitted before Group 0 is omitted. In some aspects, multiple CSI reports may be transmitted in the same OFDM symbol or PUSCH resource, the omission firstly occurs across Group 2 of all these CSI reports, then secondly occurs across Group 1 of all these reports followed by Group 0 (e.g., Group 2 of CSI report 2, 1, 0, followed by Group 1 of CSI report 2, 1, 0 followed by Group 0 of these three reports altogether).

As indicated above, FIG. 7 is provided as an example. Other examples may differ from what is described with regard to FIG. 7.

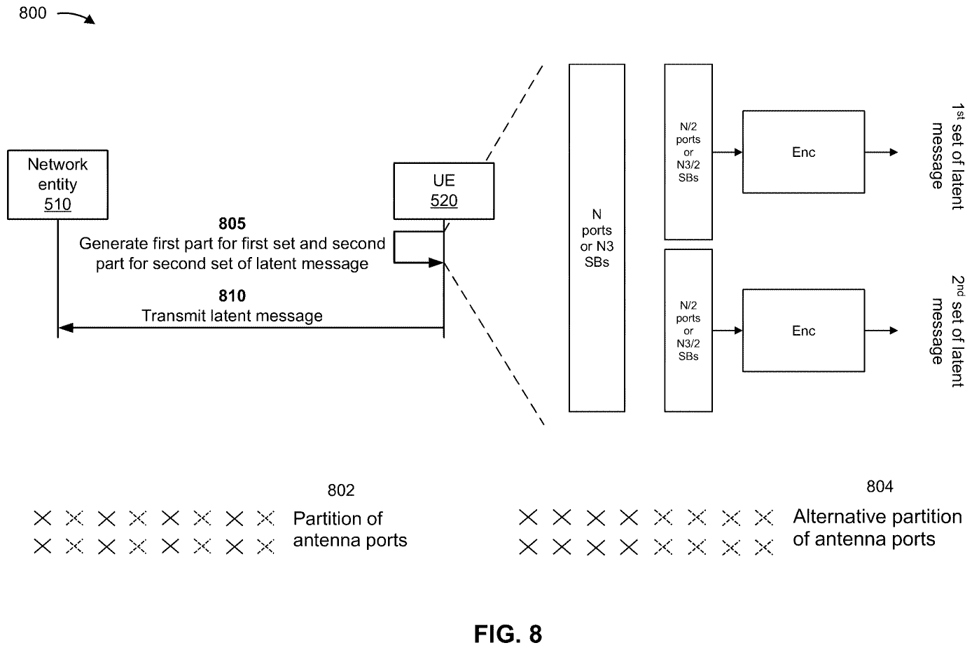

FIG. 8 is a diagram illustrating an example 800 of partitioning and subsampling, in accordance with the present disclosure.

In some aspects, the UE 520 may generate and order segments of a latent message based at least in part on ports or subbands. For example, as shown by reference number 805, the UE 520 may generate a first part of a latent message for a first set of ports or subbands and a second part of the latent message for a second set of ports or subbands. The UE 520 may partition subbands or subsample ports for the first part and the second part based at least in part on stored configuration information (e.g., configuration specified by standards). As shown by reference number 810, the UE 520 may transmit the latent message. By partitioning subbands or subsampling ports into separate sets, the sets may be reordered or organized to better fit an accurate representation of CSI feedback while conserving signaling resources.

Example 800 shows subbands that are partitioned into two sets of subbands or ports that are subsampled into two sets of ports. As shown by reference numbers 802 and 804, the UE 520 may subsample different ports into two different sets. For example, the first set of ports or subbands may include odd numbered subbands (e.g., subbands 1, 3, 5), and the second set of ports or subbands may include even numbered subbands (e.g., subbands 0, 2, 4), or vice versa. In another example, the first set of ports or subbands may include ports of a first polarization, and the second set of ports or subbands may include ports of a second polarization. In another example, the first set of ports or subbands may include odd numbered ports, and the second set of ports or subbands may include even numbered ports, or vice versa.

In some aspects, the UE 520 may generate a latent message by subsampling along the longer dimension of an antenna port layout. For example, the antenna port layout may be configured by (N1, N2) where N1<N2, where the port is indexed by n=N₁n₂+n₁ for the first half and n=N₁n₂+n₁+N₁N₂. The first part= [symbol] ∪ [symbol] , where [symbol] ={n₁, n₁+2N₁, . . . , n₁+(N₂−1)N₁, ∀n₁=0, . . . , N₁−1} and [symbol] = [symbol] +N₁N₂. The second part= [symbol] ∪ [symbol] , where [symbol] {n₁+N₁, . . . , n₁+3N₁, n₁+(N₂−2)N₁, ∀n₁=0, . . . , N₁−1} and [symbol] = [symbol] +N₁N₂. Alternatively, the first part=∪ [symbol] , where

$$𝒜 = \{ {n}_{1} , {n}_{1} + {N}_{1} , ... , {n}_{1} + \frac{( {N}_{2} - 1 )}{2} {N}_{1} , ∀ {n}_{1} = 0 , ... , {N}_{1} - 1 \} and ℬ = 𝒜 + {N}_{1} {N}_{2} .$$

The second part= [symbol] ∪ [symbol] , where

$$𝒜 \{ {n}_{1} + \frac{( {N}_{2} + 1 )}{2} {N}_{1} , ... , {n}_{1} + ( {N}_{2} - 1 ) {N}_{1} , ∀ {n}_{1} = 0 , ... , {N}_{1} - 1 \} and ℬ = 𝒜 + {N}_{1} {N}_{2} .$$

In some aspects, the UE 520 may transmit an indication (e.g., in UCI part 2) of how the first part and the second part are partitioned or subsampled. For example, the UE 520 may transmit an indication via a bitmap of length N3 (resp. P) with “1” indicating the subbands (resp. port) used to generate the first set of the latent message. In another example, the indication may be via a combinatorial number

$$( \begin{matrix}{N}_{3} \\ N\end{matrix} )$$

(resp.

$$( \begin{matrix}P \\ {P}_{1}\end{matrix} ) )$$

to indicate subbands (resp. ports) used to generate the first set of the latent message. N or P₁ may be reported in UCI part 1 or configured by the network entity 510. In an example, the indication may be via a pattern index where a pattern is chosen from a list of predefined patterns. The UE 520 may report the selected pattern using a pattern index.

As indicated above, FIG. 8 is provided as an example. Other examples may differ from what is described with regard to FIG. 8.

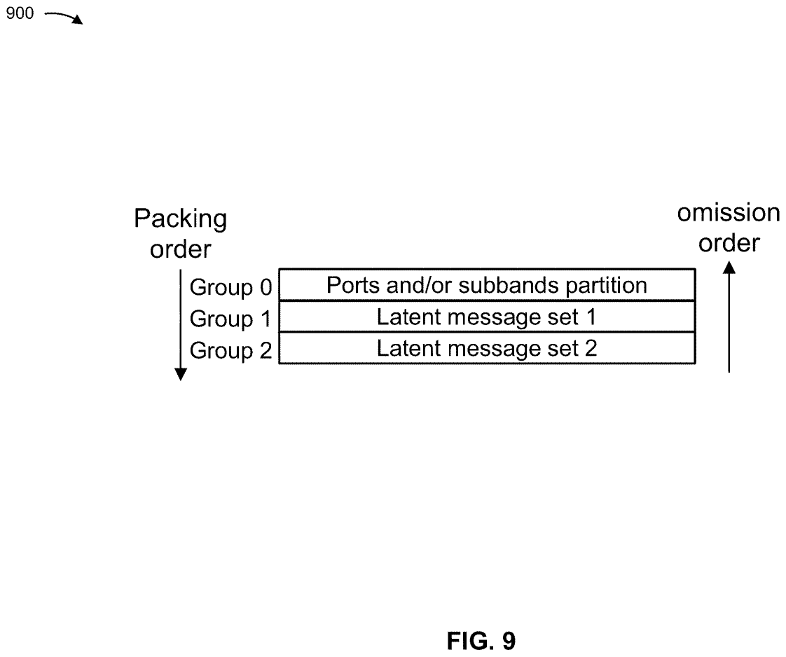

FIG. 9 is a diagram illustrating an example 900 of ordering latent message sets, in accordance with the present disclosure.

In some aspects, the first set of the subbands or ports for a latent message may have a different priority than the second set of subbands or ports. Example 900 shows that if the first set has a higher priority than the second set, the first set may be packed in UCI part 2 first before the second set is mapped in the UCI part 2. The second set may be omitted before the first set is omitted. In some aspects, multiple CSI reports may be transmitted in the same OFDM symbol or PUSCH resource, the omission firstly occurs across Group 2 of all these CSI reports, then secondly occurs across Group 1 of all these reports followed by Group 0 (e.g., Group 2 of CSI report 2, 1, 0, followed by Group 1 of CSI report 2, 1, 0 followed by Group 0 of these three reports altogether).

In some aspects, the partition of the subbands or the subsampling of the ports may be common for all layers. In some aspects, the partition and subsampling by priority may be applied per layer. For example, if per-layer encoding and decoding is used, then each layer may include the latent message first set (set 1) and the second set (set 2). The latent message set 1 of all layers may be packed together followed by a packing of latent message set 2 of all layers. If the index i is used to indicate layer i, the first set of the layer i may be represented by i.1 and the second set of the layer i may be represented by i.2. Accordingly, for layer 1, the latent message sets may be represented as 1.1, 1.2, and for layer 2, the latent message sets may be represented as 2.1, 2.2. In some aspects, the layer/set combinations may be grouped. For example, a packing order may be a group1 (1.1, 2.1) and then group2 (1.2, 2.2). That is, the latent message set 1 of all layers may be grouped together followed by a group of the latent message set 2 of all layers.

In some aspects, if rank-specific encoding and decoding is used (e.g., all layers are output together by a single encoding-decoding pair), the latent message set 1 (resp. 2) may already include the first part (resp. second part) of the latent message of all layers.

As indicated above, FIG. 9 is provided as an example. Other examples may differ from what is described with regard to FIG. 9.

FIG. 10 is a diagram illustrating an example process 1000 performed, for example, by a UE, in accordance with the present disclosure. Example process 1000 is an example where the UE (e.g., UE 120, UE 520) performs operations associated with variable bit allocations for latent message segments.

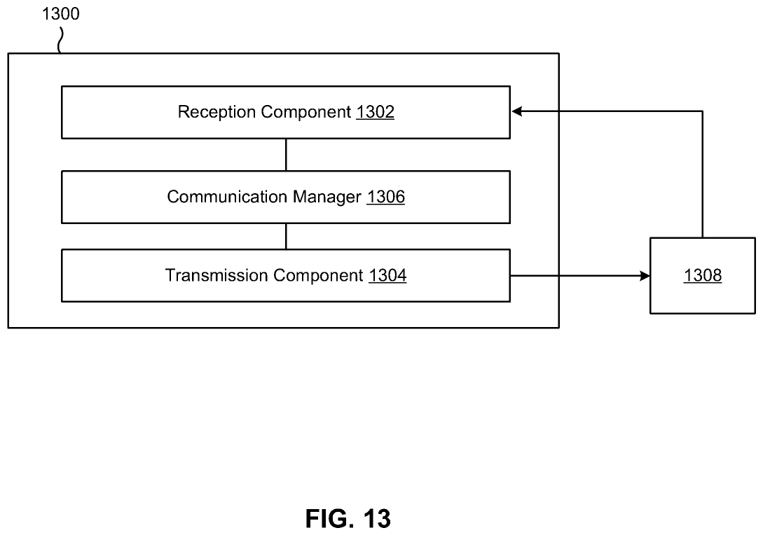

As shown in FIG. 10, in some aspects, process 1000 may include selecting variable bit allocations that indicate quantization sizes for respective segments of a latent message, the latent message representing CSI (block 1010). For example, the UE (e.g., using communication manager 1306, depicted in FIG. 13) may select variable bit allocations that indicate quantization sizes for respective segments of a latent message, the latent message representing CSI, as described above in connection with FIGS. 4-7.

As further shown in FIG. 10, in some aspects, process 1000 may include quantizing the respective segments to form the latent message based at least in part on the quantization sizes for the respective segments (block 1020). For example, the UE (e.g., using communication manager 1306, depicted in FIG. 13) may quantize the respective segments to form the latent message based at least in part on the quantization sizes for the respective segments, as described above in connection with FIGS. 4-7.

As further shown in FIG. 10, in some aspects, process 1000 may include transmitting the variable bit allocations with the latent message (block 1030). For example, the UE (e.g., using transmission component 1304 and/or communication manager 1306, depicted in FIG. 13) may transmit the variable bit allocations with the latent message, as described above in connection with FIGS. 4-7.

Process 1000 may include additional aspects, such as any single aspect or any combination of aspects described below and/or in connection with one or more other processes described elsewhere herein.

In a first aspect, transmitting the variable bit allocations with the latent message includes transmitting the variable bit allocations and the latent message in UCI part 2.

In a second aspect, alone or in combination with the first aspect, transmitting the variable bit allocations with the latent message includes transmitting the variable bit allocations in UCI part 1 and the latent message in UCI part 2.

In a third aspect, alone or in combination with one or more of the first and second aspects, process 1000 includes selecting a total size of the latent message.

In a fourth aspect, alone or in combination with one or more of the first through third aspects, transmitting the variable bit allocations with the latent message includes transmitting an indication of the total size in UCI part 1, the variable bit allocations in UCI part 2, and the latent message in UCI part 2.

In a fifth aspect, alone or in combination with one or more of the first through fourth aspects, selecting the variable bit allocations includes selecting the variable bit allocations from a set of multiple bit allocations.

In a sixth aspect, alone or in combination with one or more of the first through fifth aspects, process 1000 includes encoding a precoding matrix to obtain the latent message with a dimension of the latent message.

In a seventh aspect, alone or in combination with one or more of the first through sixth aspects, selecting the variable bit allocations includes selecting the variable bit allocations based at least in part on one or more trained analysis models.

In an eighth aspect, alone or in combination with one or more of the first through seventh aspects, at least one of the trained analysis models outputs a probability or entropy of each segment of the respective segments.

In a ninth aspect, alone or in combination with one or more of the first through eighth aspects, process 1000 includes prioritizing the quantized segments in the latent message based at least in part on bit allocation sizes.

In a tenth aspect, alone or in combination with one or more of the first through ninth aspects, process 1000 includes prioritizing the quantized segments in the latent message further based at least in part on quantized segment indices.

In an eleventh aspect, alone or in combination with one or more of the first through tenth aspects, process 1000 includes prioritizing the quantized segments in the latent message further based at least in part on layer indices.

In a twelfth aspect, alone or in combination with one or more of the first through eleventh aspects, process 1000 includes grouping the variable bit allocations in a bit allocation group, grouping the quantized segments into one or more segment groups, ordering the bit allocation group first in the UCI, and ordering the one or more segment groups next in the UCI in order of highest priority to lowest priority.

In a thirteenth aspect, alone or in combination with one or more of the first through twelfth aspects, process 1000 includes grouping the variable bit allocations in a bit allocation group, grouping the quantized segments into one or more segment groups, and omitting at least one segment group of the one or more segment groups from transmission in order of lowest priority to highest priority.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network entity, in accordance with the present disclosure. Example process 1100 is an example where the network entity (e.g., network node 110, network entity 510) performs operations associated with variable bit allocations for latent message segments.

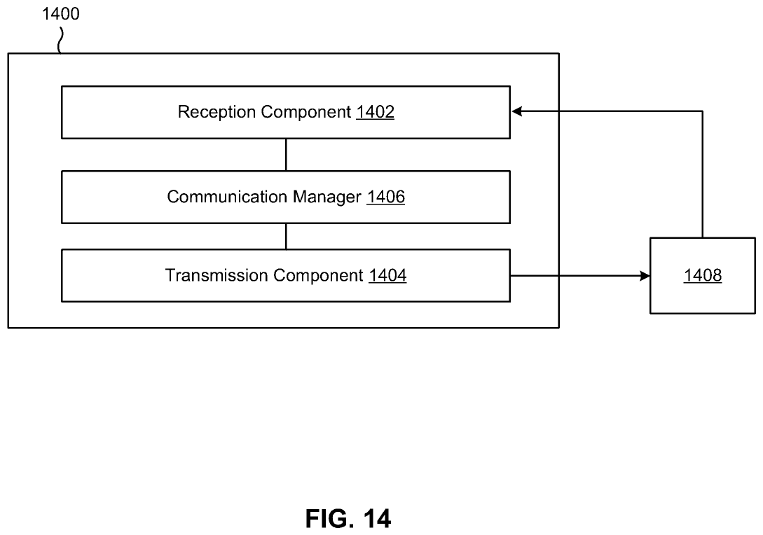

As shown in FIG. 11, in some aspects, process 1100 may include receiving variable bit allocations with a latent message that represents CSI, the variable bit allocations indicating quantization sizes for quantized segments of the latent message (block 1110). For example, the network entity (e.g., using reception component 1402 and/or communication manager 1406, depicted in FIG. 14) may receive variable bit allocations with a latent message that represents CSI, the variable bit allocations indicating quantization sizes for quantized segments of the latent message, as described above in connection with FIGS. 4-7.

As further shown in FIG. 11, in some aspects, process 1100 may include decoding the quantized segments based at least in part on the quantization sizes indicated by the variable bit allocations (block 1120). For example, the network entity (e.g., using communication manager 1406, depicted in FIG. 14) may decode the quantized segments based at least in part on the quantization sizes indicated by the variable bit allocations, as described above in connection with FIGS. 4-7.

Process 1100 may include additional aspects, such as any single aspect or any combination of aspects described below and/or in connection with one or more other processes described elsewhere herein.

In a first aspect, receiving the variable bit allocations with the latent message includes receiving the variable bit allocations and the latent message in UCI part 2.

In a second aspect, alone or in combination with the first aspect, receiving the variable bit allocations with the latent message includes receiving the variable bit allocations in UCI part 1 and the latent message in UCI part 2.

In a third aspect, alone or in combination with one or more of the first and second aspects, receiving the variable bit allocations with the latent message includes receiving an indication of a total size of the latent message in UCI part 1, the variable bit allocations in UCI part 2, and the latent message in UCI part 2.

In a fourth aspect, alone or in combination with one or more of the first through third aspects, the quantized segments are ordered in the latent message by one or more of bit allocation sizes, quantized segment indices, or layer indices.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a UE, in accordance with the present disclosure. Example process 1200 is an example where the UE (e.g., UE 120, UE 520) performs operations associated with variable bit allocations for latent message segments.

As shown in FIG. 12, in some aspects, process 1200 may include generating a first part of a latent message for a first set of ports or subbands and a second part of the latent message for a second set of ports or subbands, the latent message being associated with CSI (block 1210). For example, the UE (e.g., using communication manager 1306, depicted in FIG. 13) may generate a first part of a latent message for a first set of ports or subbands and a second part of the latent message for a second set of ports or subbands, the latent message being associated with CSI, as described above in connection with FIGS. 4-9.

As further shown in FIG. 12, in some aspects, process 1200 may include transmitting the latent message (block 1220). For example, the UE (e.g., using transmission component 1304 and/or communication manager 1306, depicted in FIG. 13) may transmit the latent message, as described above in connection with FIGS. 4-9.

Process 1200 may include additional aspects, such as any single aspect or any combination of aspects described below and/or in connection with one or more other processes described elsewhere herein.

In a first aspect, generating the first part and the second part includes partitioning subbands or subsampling ports for the first part and the second part based at least in part on stored configuration information.

In a second aspect, alone or in combination with the first aspect, the first set of ports or subbands includes odd numbered subbands and the second set of ports or subbands includes even numbered subbands.

In a third aspect, alone or in combination with one or more of the first and second aspects, the first set of ports or subbands includes ports of a first polarization and the second set of ports or subbands includes ports of a second polarization.

In a fourth aspect, alone or in combination with one or more of the first through third aspects, the first set of ports or subbands includes odd numbered ports and the second set of ports or subbands includes even numbered ports.

In a fifth aspect, alone or in combination with one or more of the first through fourth aspects, process 1200 includes transmitting an indication of how the first part and the second part are partitioned or subsampled.

In a sixth aspect, alone or in combination with one or more of the first through fifth aspects, the first part has a higher priority than the second part, and the first part and the second part are ordered or omitted in UCI part 2 by priority.

In a seventh aspect, alone or in combination with one or more of the first through sixth aspects, generating the first part and the second part includes partitioning or subsampling the latent message for multiple layers.

In an eighth aspect, alone or in combination with one or more of the first through seventh aspects, generating the first part and the second part includes partitioning subbands or subsampling ports for the first part and the second part per layer.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE (e.g., UE 120, UE 520), or a UE may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 140 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 1-9. Additionally, or alternatively, the apparatus 1300 may be configured to perform one or more processes described herein, such as process 1000 of FIG. 10, process 1200 of FIG. 12, or a combination thereof. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory.

For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

In some aspects, the communication manager 1306 may select variable bit allocations that indicate quantization sizes for respective segments of a latent message, the latent message representing CSI. The communication manager 1306 may quantize the respective segments to form the latent message based at least in part on the quantization sizes for the respective segments. The transmission component 1304 may transmit the variable bit allocations with the latent message.

The communication manager 1306 may select a total size of the latent message. The communication manager 1306 may encode a precoding matrix to obtain the latent message with a dimension of the latent message. The communication manager 1306 may prioritize the quantized segments in the latent message based at least in part on bit allocation sizes. The communication manager 1306 may prioritize the quantized segments in the latent message further based at least in part on quantized segment indices. The communication manager 1306 may prioritize the quantized segments in the latent message further based at least in part on layer indices. The communication manager 1306 may prioritize the quantized segments in the latent message further based at least in part on layer indices. The communication manager 1306 may prioritize the quantized segments in the latent message further based at least in part on quantized segment indices.

The communication manager 1306 may group the variable bit allocations in a bit allocation group. The communication manager 1306 may group the quantized segments into one or more segment groups. The communication manager 1306 may order the bit allocation group first in the UCI. The communication manager 1306 may order the one or more segment groups next in the UCI in order of highest priority to lowest priority. The communication manager 1306 may group the variable bit allocations in a bit allocation group. The communication manager 1306 may group the quantized segments into one or more segment groups. The communication manager 1306 may omit at least one segment group of the one or more segment groups from transmission in order of lowest priority to highest priority.

In some aspects, the communication manager 1306 may generate a first part of a latent message for a first set of ports or subbands and a second part of the latent message for a second set of ports or subbands, the latent message being associated with CSI. The transmission component 1304 may transmit the latent message. The transmission component 1304 may transmit an indication of how the first part and the second part are partitioned or subsampled.

The number and arrangement of components shown in FIG. 13 are provided as an example. In practice, there may be additional components, fewer components, different components, or differently arranged components than those shown in FIG. 13.

Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a network entity (e.g., network node 110, network entity 510), or a network entity may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 150 described in connection with FIG. 1.

As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIGS. 1-9. Additionally, or alternatively, the apparatus 1400 may be configured to perform one or more processes described herein, such as process 1100 of FIG. 11. In some aspects, the apparatus 1400 and/or one or more components shown in FIG. 14 may include one or more components of the network entity described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the network entity described in connection with FIG. 2.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, a modem, a modulator, a transmit MIMO processor, a transmit processor, a controller/processor, a memory, or a combination thereof, of the network entity described in connection with FIG. 2. In some aspects, the transmission component 1404 may be co-located with the reception component 1402 in a transceiver.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The reception component 1402 may receive variable bit allocations with a latent message that represents CSI, the variable bit allocations indicating quantization sizes for quantized segments of the latent message. The communication manager 1406 may decode the quantized segments based at least in part on the quantization sizes indicated by the variable bit allocations.

The number and arrangement of components shown in FIG. 14 are provided as an example. In practice, there may be additional components, fewer components, different components, or differently arranged components than those shown in FIG. 14.

Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a user equipment (UE), comprising: selecting variable bit allocations that indicate quantization sizes for respective segments of a latent message, the latent message representing channel state information; quantizing the respective segments to form the latent message based at least in part on the quantization sizes for the respective segments; and transmitting the variable bit allocations with the latent message.

Aspect 2: The method of Aspect 1, wherein transmitting the variable bit allocations with the latent message includes transmitting the variable bit allocations and the latent message in uplink control information part 2.

Aspect 3: The method of Aspect 1, wherein transmitting the variable bit allocations with the latent message includes transmitting the variable bit allocations in uplink control information (UCI) part 1 and the latent message in UCI part 2.

Aspect 4: The method of any of Aspects 1-3, further comprising selecting a total size of the latent message.

Aspect 5: The method of Aspect 1, wherein transmitting the variable bit allocations with the latent message includes transmitting an indication of the total size in uplink control information (UCI) part 1, the variable bit allocations in UCI part 2, and the latent message in UCI part 2.

Aspect 6: The method of any of Aspects 1-5, wherein selecting the variable bit allocations includes selecting the variable bit allocations from a set of multiple bit allocations.

Aspect 7: The method of any of Aspects 1-6, further comprising encoding a precoding matrix to obtain the latent message with a dimension of the latent message.

Aspect 8: The method of any of Aspects 1-7, wherein selecting the variable bit allocations includes selecting the variable bit allocations based at least in part on one or more trained analysis models.

Aspect 9: The method of Aspect 8, wherein at least one of the trained analysis models outputs a probability or entropy of each segment of the respective segments.

Aspect 10: The method of any of Aspects 1-9, further comprising prioritizing the quantized segments in the latent message based at least in part on bit allocation sizes.

Aspect 11: The method of Aspect 10, further comprising prioritizing the quantized segments in the latent message further based at least in part on quantized segment indices.

Aspect 12: The method of Aspect 11, further comprising prioritizing the quantized segments in the latent message further based at least in part on layer indices.

Aspect 13: The method of Aspect 10, further comprising prioritizing the quantized segments in the latent message further based at least in part on layer indices.

Aspect 14: The method of Aspect 13, further comprising prioritizing the quantized segments in the latent message further based at least in part on quantized segment indices.

Aspect 15: The method of any of Aspects 1-14, further comprising: grouping the variable bit allocations in a bit allocation group; grouping the quantized segments into one or more segment groups; ordering the bit allocation group first in uplink control information (UCI); and ordering the one or more segment groups next in the UCI in order of highest priority to lowest priority.

Aspect 16: The method of any of Aspects 1-15, further comprising: grouping the variable bit allocations in a bit allocation group; grouping the quantized segments into one or more segment groups; and omitting at least one segment group of the one or more segment groups from transmission in order of lowest priority to highest priority.

Aspect 17: A method of wireless communication performed by a network entity, comprising: receiving variable bit allocations with a latent message that represents channel state information, the variable bit allocations indicating quantization sizes for quantized segments of the latent message; and decoding the quantized segments based at least in part on the quantization sizes indicated by the variable bit allocations.

Aspect 18: The method of Aspect 17, wherein receiving the variable bit allocations with the latent message includes receiving the variable bit allocations and the latent message in uplink control information part 2.

Aspect 19: The method of Aspect 17, wherein receiving the variable bit allocations with the latent message includes receiving the variable bit allocations in uplink control information (UCI) part 1 and the latent message in UCI part 2.

Aspect 20: The method of Aspect 17, wherein receiving the variable bit allocations with the latent message includes receiving an indication of a total size of the latent message in uplink control information (UCI) part 1, the variable bit allocations in UCI part 2, and the latent message in UCI part 2.

Aspect 21: The method of any of Aspects 17-20, wherein the quantized segments are ordered in the latent message by one or more of bit allocation sizes, quantized segment indices, or layer indices.

Aspect 22: A method of wireless communication performed by a user equipment (UE), comprising: generating a first part of a latent message for a first set of ports or subbands and a second part of the latent message for a second set of ports or subbands, the latent message being associated with channel state information; and transmitting the latent message.

Aspect 23: The method of Aspect 22, wherein generating the first part and the second part includes partitioning subbands or subsampling ports for the first part and the second part based at least in part on stored configuration information.

Aspect 24: The method of any of Aspects 22-23, wherein the first set of ports or subbands includes odd numbered subbands and the second set of ports or subbands includes even numbered subbands.

Aspect 25: The method of any of Aspects 22-24, wherein the first set of ports or subbands includes ports of a first polarization and the second set of ports or subbands includes ports of a second polarization.

Aspect 26: The method of any of Aspects 22-25, wherein the first set of ports or subbands includes odd numbered ports and the second set of ports or subbands includes even numbered ports.

Aspect 27: The method of any of Aspects 22-26, further comprising transmitting an indication of how the first part and the second part are partitioned or subsampled.

Aspect 28: The method of any of Aspects 22-27, wherein the first part has a higher priority than the second part, and wherein the first part and the second part are ordered or omitted in uplink control information (UCI) part 2 by priority.

Aspect 29: The method of any of Aspects 22-28, wherein generating the first part and the second part includes partitioning or subsampling the latent message for multiple layers.

Aspect 30: The method of any of Aspects 22-29, wherein generating the first part and the second part includes partitioning subbands or subsampling ports for the first part and the second part per layer.

Aspect 31: An apparatus for wireless communication at a device, comprising a processor; memory coupled with the processor; and instructions stored in the memory and executable by the processor to cause the apparatus to perform the method of one or more of Aspects 1-30.

Aspect 32: A device for wireless communication, comprising a memory and one or more processors coupled to the memory, the one or more processors configured to perform the method of one or more of Aspects 1-30.

Aspect 33: An apparatus for wireless communication, comprising at least one means for performing the method of one or more of Aspects 1-30.

Aspect 34: A non-transitory computer-readable medium storing code for wireless communication, the code comprising instructions executable by a processor to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
one or more memories; and
one or more processors, coupled to the one or more memories, configured to:
select variable bit allocations that indicate quantization sizes for respective segments of a latent message, the latent message representing channel state information;
quantize the respective segments to form the latent message based at least in part on the quantization sizes for the respective segments; and
transmit the variable bit allocations with the latent message.

2. The UE of claim 1, wherein the one or more processors, to transmit the variable bit allocations with the latent message, are configured to transmit the variable bit allocations and the latent message in uplink control information part 2.

3. The UE of claim 1, wherein the one or more processors, to transmit the variable bit allocations with the latent message, are configured to transmit the variable bit allocations in uplink control information (UCI) part 1 and the latent message in UCI part 2.

4. The UE of claim 1, wherein the one or more processors are configured to select a total size of the latent message.

5. The UE of claim 4, wherein the one or more processors, to transmit the variable bit allocations with the latent message, are configured to transmit an indication of the total size in uplink control information (UCI) part 1, the variable bit allocations in UCI part 2, and the latent message in UCI part 2.

6. The UE of claim 1, wherein the one or more processors, to select the variable bit allocations, are configured to select the variable bit allocations from a set of multiple bit allocations.

7. The UE of claim 1, wherein the one or more processors are configured to encode a precoding matrix to obtain the latent message with a dimension of the latent message.

8. The UE of claim 1, wherein the one or more processors, to select the variable bit allocations, are configured to select the variable bit allocations based at least in part on one or more trained analysis models.

9. The UE of claim 8, wherein at least one of the trained analysis models outputs a probability or entropy of each segment of the respective segments.

10. The UE of claim 1, wherein the one or more processors are configured to prioritize the quantized segments in the latent message based at least in part on bit allocation sizes.

11. The UE of claim 10, wherein the one or more processors are configured to prioritize the quantized segments in the latent message further based at least in part on quantized segment indices.

12. The UE of claim 11, wherein the one or more processors are configured to prioritize the quantized segments in the latent message further based at least in part on layer indices.

13. The UE of claim 10, wherein the one or more processors are configured to prioritize the quantized segments in the latent message further based at least in part on layer indices.

14. The UE of claim 13, wherein the one or more processors are configured to prioritize the quantized segments in the latent message further based at least in part on quantized segment indices.

15. The UE of claim 1, wherein the one or more processors are configured to:
group the variable bit allocations in a bit allocation group;
group the quantized segments into one or more segment groups;
order the bit allocation group first in uplink control information (UCI); and
order the one or more segment groups next in the UCI in order of highest priority to lowest priority.

16. The UE of claim 1, wherein the one or more processors are configured to:
group the variable bit allocations in a bit allocation group;
group the quantized segments into one or more segment groups; and
omit at least one segment group of the one or more segment groups from transmission in order of lowest priority to highest priority.

17. A network entity for wireless communication, comprising:
one or more memories; and
one or more processors, coupled to the one or more memories, configured to:
receive variable bit allocations with a latent message that represents channel state information, the variable bit allocations indicating quantization sizes for quantized segments of the latent message; and
decode the quantized segments based at least in part on the quantization sizes indicated by the variable bit allocations.

18. The network entity of claim 17, wherein the one or more processors, to receive the variable bit allocations with the latent message, are configured to receive the variable bit allocations and the latent message in uplink control information part 2.

19. The network entity of claim 17, wherein the one or more processors, to receive the variable bit allocations with the latent message, are configured to receive the variable bit allocations in uplink control information (UCI) part 1 and the latent message in UCI part 2.

20. The network entity of claim 17, wherein the one or more processors, to receive the variable bit allocations with the latent message, are configured to receive an indication of a total size of the latent message in uplink control information (UCI) part 1, the variable bit allocations in UCI part 2, and the latent message in UCI part 2.

21.-30. (canceled)
